(19) United States
(12) Patent Application Publication
(10) Pub. No.: US 2022/0148491 A1
(43) Pub. Date: May 12, 2022

(54) Dual-line cascade application system and implementation method thereof for simultaneously supplying electrical power and transmitting data

(71) Applicants: Binyang Huang, Guangdong (CN); Qinyang Huang, Guangdong (CN)

(72) Inventors: Binyang Huang, Guangdong (CN); Qinyang Huang, Guangdong (CN)

(21) Appl. No.: 17/185,994

(22) Filed: Feb. 26, 2021

(30) Foreign Application Priority Data
Nov. 11, 2020 (CN) 202011274698.8

(51) Int. Cl. G09G 3/32; H05B 45/325

(52) U.S. Cl. CPC G09G 3/32; G09G 2330/021; H05B 45/325

(57) ABSTRACT

The present invention discloses a dual-line cascade application system and implementation method thereof for simultaneously supplying electrical power and transmitting data. The dual-line cascade application system comprises a controller, cascade chips and LED lights. The controller is connected to the cascade chips. The cascade chips are connected to the LED lights. Each of the cascade chips is provided with a voltage clamp module, an electrical power supply module, a data storage module, a PWM constant current output driving circuit, an R end, a G end, a B end, a W end, a VCC/DATA end and a GND/DATA end, as well as a data sampling and calibration module, a power line data sampling and transmission module, a chip initial address setting by command module, a module which determines if E-fuse address is identical to chip initial address, and an E-fuse module which are sequentially connected.

### BACKGROUND OF THE INVENTION

The present invention relates to cascade application systems and particularly pertains to a dual-line cascade application system and implementation method thereof for simultaneously supplying electrical power and transmitting data.

An LED display cascade application system comprises a controller, cascade chips and so forth. The controller transmits data; the cascade chips receive data, display and forward data and so forth. Existing LED display cascade application systems are divided into LED display series application systems and LED display parallel application systems.

LED display series application systems need only one controller to generate and transmit data, and the series cascade chips receive data, display and forward data. LED display series application system has the advantage of low costs in respect of general display application effects, as chip address units which are independent and can be set anytime and signal amplifiers are not necessary. Apart from the advantage of low costs, in LED display series application systems, if one of the chips is damaged, it would cause subsequent display application error and thus affect the display effect of the entire LED display series application system, resulting in subsequent display error or increase in maintenance and replacement costs. The cascade chips in LED display series application systems now are improved as breakpoint continuous transmission chips where one of the lines is used for data transmission and one or more lines are reserved as communication ports, so as to reduce the possibility of LED display series application system display errors resulted from several defective pixels during application process (as long as the defective pixels are not consecutive, there would be no display error for the LED display series application system). However, it is not possible to avoid completely, and therefore LED display parallel application systems are considered in systems where the reliability requirement is high.

In LED display parallel application systems, the controller generates and transmits data and connects to input paths of all parallel chips. With different chip addresses of the parallel chips, data of the chips is obtained from parallel data lines and displayed. LED display parallel application systems have higher reliability. In an LED display parallel application system, damage of one of the parallel chips would not affect data sampling and display of other parallel chips of the LED display parallel application system. Besides, LED display parallel systems are higher in costs, as chip address units which can be set anytime are required (using EEPROM chip to package with the parallel chips). IIC protocol is used for communication between the EEPROM chip and the parallel chips. When the system power supply is not stable (system power-on or system power-down after system error and then power-on again), IIC protocol communication error between the EEPROM chip and the parallel chips is possible, resulting in address writing error and thus abnormal display. In existing LED display parallel application systems, standard DMX512 communication protocol is used, in which re-transmission of display data starts from address 0. Assuming that the LED display parallel application system has 200 cascade chips, and next time only the end 100 cascade chips display color change, then the display data is still data of the 200 chips, and the data of the beginning 100 chips is invalid data, thus reducing display date refresh rate. Due to attenuation of transmission signals, it is also necessary to provide signal amplifiers and so forth in the LED display parallel application systems to amplify transmission signals, so as to ensure accurate data sampling and display of the LED display parallel application system.

Therefore, to take care of both costs and performance, existing LED display cascade application systems consider dual-line cascade application which simultaneously supplying electrical power and transmitting data by using only VDD and GND lines to connect cascade application systems, so as to simplify the cascade application system and reduce costs at the same time.

Therefore, a dual-line cascade application system and implementation method thereof for simultaneously supplying electrical power and transmitting data are highly anticipated by the persons skilled in the art.

### BRIEF SUMMARY OF THE INVENTION

The present invention provides a dual-line cascade application system and implementation method thereof for simultaneously supplying electrical power and transmitting data to overcome the disadvantages of low reliability and low display refresh rate of existing dual-line cascade application systems.

In order to attain the above objects, the present invention provides the following technical solutions:

A dual-line cascade application system for simultaneously supplying electrical power and transmitting data comprises a controller, cascade chips and LED lights; the controller is connected to the cascade chips; the cascade chips are connected to the LED lights; characterized in that: each of the cascade chips is provided with a voltage clamp module (the voltage clamp module achieves stable and accurate electrical power and data transmission during cascade application), an electrical power supply module, a data storage module, a PWM constant current output driving circuit, an R end, a G end, a B end, a W end, a VCC/DATA end and a GND/DATA end, as well as a data sampling and calibration module, a power line data sampling and transmission module, a chip initial address setting by command module, a module which determines if E-fuse address is identical to chip initial address, and an E-fuse module (for storing chip address, and the E-fuse is blown out to determine different chip addresses anytime during manufacture and application process to facilitate manufacture and application) which are sequentially connected;

the VCC/DATA end is connected to the voltage clamp module, the data sampling and calibration module and the power line data sampling and transmission module respectively; the voltage clamp module has an output end which is connected to the GND/DATA end and the electrical power supply module respectively; the electrical power supply module has an output end which is connected to the data sampling and calibration module, the power line data sampling and transmission module, the chip initial address setting by command module, the module which determines if E-fuse address is identical to chip initial address, the E-fuse module, the data storage module and the PWM constant current output driving circuit respectively to supply power; the power line data sampling and transmission module has an output end which is connected to the chip initial address setting by command module and the data storage module respectively; the module which determines if E-fuse address is identical to chip initial address is connected to the data storage module; the PWM constant current output driving circuit is connected to the R end, the G end, the B end and the W end;

each of the cascade chips is further provided with an oscillation circuit and a reset circuit; the oscillation circuit and the reset circuit are connected between the electrical power supply module and the power line data sampling and transmission module.

Furthermore, the controller is provided with a VDD end and a GND end; the VDD end and the GND end of the controller are connected to the VDD and GND ends of all the cascade chips respectively; each of the LED lights is connected to the R end, the G end, the B end and the W end of each of the cascade chips.

The implementation method of the dual-line cascade application system for simultaneously supplying electrical power and transmitting data of the present invention comprises the following steps:

Step 1: Achieve stable and accurate power and data transmission during cascade application via the voltage clamp module;

Step 2: Data is transmitted to the data sampling and calibration module; data transmission criteria is changed in real time via the data sampling and calibration module for accurate data sampling and transmission; after data sampling and transmission, the power line data sampling and transmission module samples and transmits data;

Step 3: If the data transmitted is determined as an address writing command, write address on the E-fuse module of the chip and set chip address; otherwise repeat data sampling, determination and transmission;

Step 4: If the data transmitted is determined as a chip initial address setting command data, set chip initial address, and the chip initial address is added by one after receiving a group of display command data; otherwise repeat data sampling, determination and transmission;

Step 5: If the data transmitted is determined as display command data, determine if the E-fuse address is identical to the chip initial address; if yes, sample and store display data of corresponding address and output display with PWM constant current; if not, then ignore.

In comparison with the prior art, the present invention has the following advantages:

In respect of cascade application, the present invention transmits data with power, thus attaining dual-line cascade application (power line and ground line), and saving manufacture costs. The data sampling and calibration module changes data transmission criteria in real time for accurate data sampling and transmission, thus ensuring accurate data transmission and accurate dual-line cascade application. The E-fuse module can be blown out at any time to determine chip address, thereby simplifying manufacture process and realizing automatic production. Setting chip initial address reduces invalid data, thus increasing refresh rate of dual-line cascade application and improving display effect. To conclude, in respect of cascade application, the present invention ensures accuracy of cascade application, saves manufacture costs, simplifies manufacture process, realizes automatic production, improves display effect and so forth.

### BRIEF DESCRIPTION OF THE DRAWINGS

FIG. 1 is a schematic diagram of a dual-line cascade application system.

FIG. 2 is a schematic block diagram of the internal circuit of a conventional dual-line cascade chip available in the marketplace.

FIG. 3 is a schematic block diagram of the internal circuit of the dual-line cascade chip of the present invention.

FIG. 4 is a schematic diagram of the implementation steps of the present invention.

### DETAILED DESCRIPTION OF THE INVENTION

The present invention is further described in detail herein with the accompanying drawings.

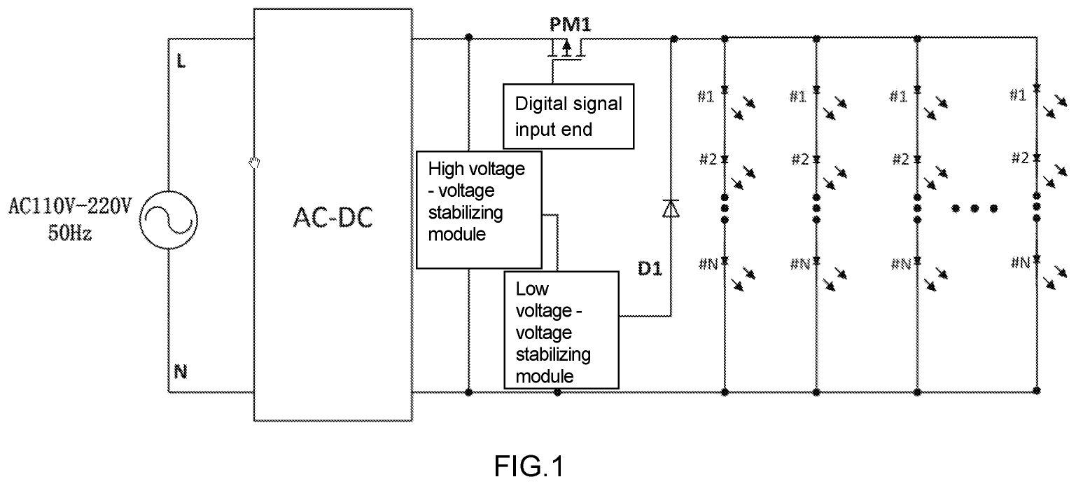

FIG. 1 is a schematic diagram of a dual-line cascade application system.

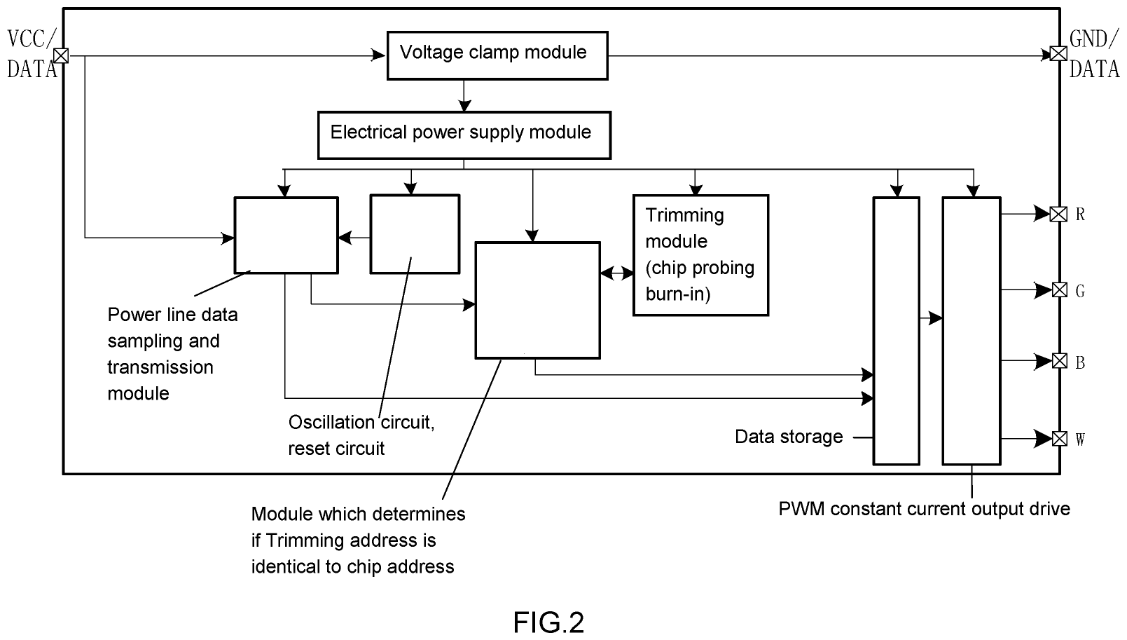

FIG. 2 is a schematic block diagram of the internal circuit of a conventional dual-line cascade chip available in the marketplace. At this time, the cascade chip performs data sampling and transmission directly from the power line. When the dual-line cascade application system has a greater length, that is when more cascade chips are connected in series/parallel in the dual-line cascade application system, parasitic resistance and capacitance result in abnormal data transmission on the power line (the width of high voltage becomes longer or shorter), and thereby causing address writing error, abnormal display and so forth. At the same time, in common dual-line cascade application systems in the marketplace, data transmission includes address and display; there is more date in a cascade chip, and thus fewer cascade chips are required in dual-line cascade application systems under same refresh rate. During chip probing, Trimming module is blown out to determine chip address; the dual-line cascade application system uses camera visual identification, phototransistor identification or the like to cooperate with predetermined addressing program to complete cascade chip addressing during manufacture; the manufacture costs are high, and the manufacture processes are complex.

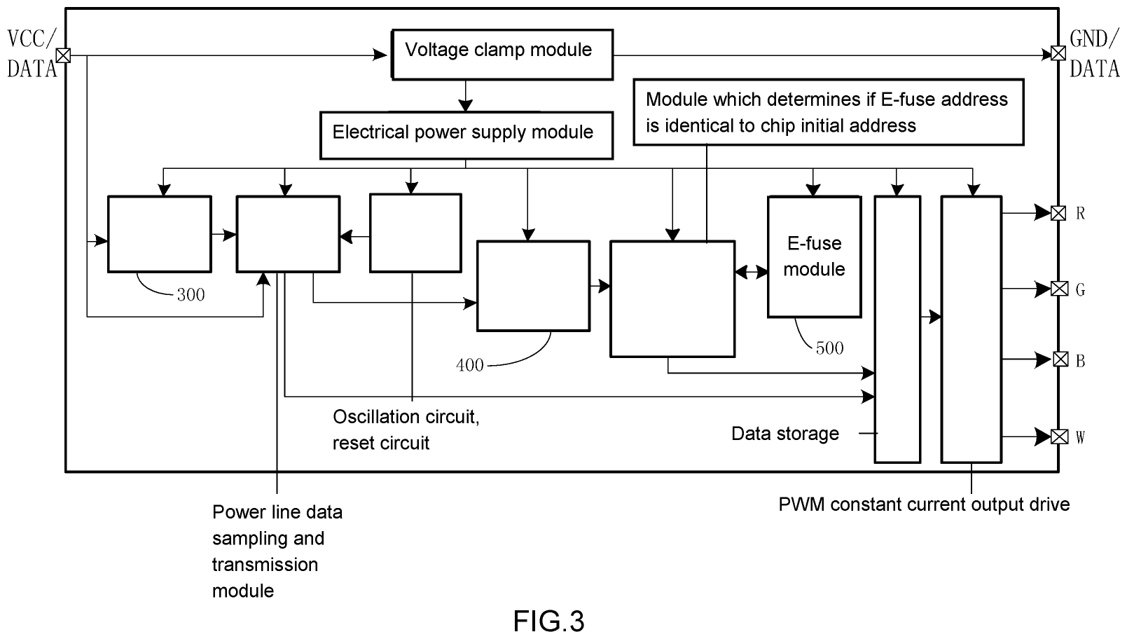

FIG. 3 is a schematic block diagram of the internal circuit of the dual-line cascade chip of the present invention. At this time, E-fuse module address is used instead of Trimming module; a data sampling and calibration module is added; a chip initial address setting by command module, a module for determining if E-fuse address is identical to chip initial address and so forth are also added. When the dual-line cascade application system has a greater length, that is when more cascade chips are connected in series/parallel in the dual-line cascade application system, parasitic resistance and capacitance result in abnormal data transmission on the power line (the width of high voltage becomes longer or shorter). The dual-line cascade chips of the present invention, by means of the data sampling and calibration module, can still accurately sample and transmit data, thereby ensuring accurate functionality. Each of the dual-line cascade chips of the present invention is additionally provided with a chip initial address setting by command module, so that transmission of data can command address setting, and the address sequence is then added by one, thereby reducing transmission data bits of each chip, and increasing the number of cascade chips of the dual-line cascade application system under same refresh rate. The E-fuse module can be blown out to determine chip address at any time in the cascade chips (e.g. it is possible to blow out the E-fuse module to determine chip address during manufacture), so the dual-line cascade application system can blow out and determine chip address during manufacture as requested, generate dual-line cascade application system according to the sequence defined by the controller, and receive data transmitted from the controller and display correctly. The manufacturing costs are low and the manufacturing processes are simple.

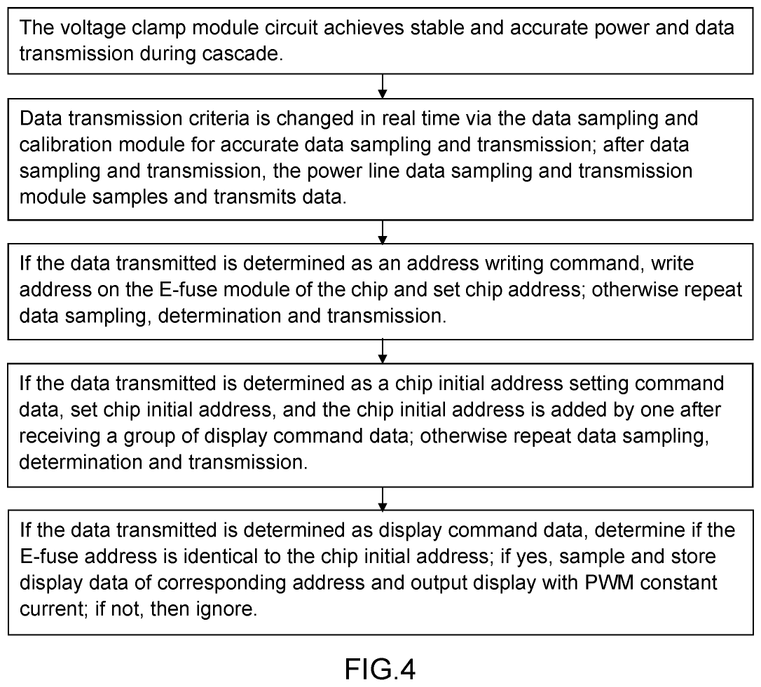

With reference to FIGS. 2, 3 and 4, the dual-line cascade application system for simultaneously supplying electrical power and transmitting data of the present invention comprises a controller, cascade chips and LED lights. The controller is connected to the cascade chips; the cascade chips are connected to the LED lights. It is characterized in that each of the cascade chips is provided with a voltage clamp module (the voltage clamp module achieves stable and accurate power and data transmission during cascade application), an electrical power supply module, a data storage module, a PWM constant current output driving circuit, an R end, a G end, a B end, a W end, a VCC/DATA end and a GND/DATA end, as well as a data sampling and calibration module, a power line data sampling and transmission module, a chip initial address setting by command module, a module which determines if E-fuse address is identical to chip initial address, and an E-fuse module (for storing chip address, and the E-fuse is blown out to determine different chip addresses anytime during manufacture and application process to facilitate manufacture and application) which are sequentially connected.

The VCC/DATA end is connected to the voltage clamp module, the data sampling and calibration module and the power line data sampling and transmission module respectively. The voltage clamp module has an output end which is connected to the GND/DATA end and the electrical power supply module respectively. The electrical power supply module has an output end which is connected to the data sampling and calibration module, the power line data sampling and transmission module, the chip initial address setting by command module, the module which determines if E-fuse address is identical to chip initial address, the E-fuse module, the data storage module and the PWM constant current output driving circuit respectively to supply power. The power line data sampling and transmission module has an output end which is connected to the chip initial address setting by command module and the data storage module respectively. The module which determines if E-fuse address is identical to chip initial address is connected to the data storage module. The PWM constant current output driving circuit is connected to the R end, the G end, the B end and the W end.

Each of the cascade chips is further provided with an oscillation circuit and a reset circuit. The oscillation circuit and the reset circuit are connected between the electrical power supply module and the power line data sampling and transmission module.

Furthermore, the controller is provided with a VDD end and a GND end. The VDD end and the GND end of the controller are connected to the VDD and GND ends of all the cascade chips respectively. Each of the LED lights is connected to the R end, the G end, the B end and the W end of each of the cascade chips.

As illustrated in FIG. 3, the implementation method of the dual-line cascade application system for simultaneously supplying electrical power and transmitting data of the present invention comprises the following steps:

The cascade chips are powered on, and the voltage clamp module achieves stable and accurate power and data transmission during cascade application;

The cascade chips change data transmission criteria in real time via the data sampling and calibration module 300 for accurate data sampling and transmission. After data sampling and transmission, the power line data sampling and transmission module samples and transmits data;

If the data transmitted is determined as an address writing command, write address on the E-fuse module 500 of the chip and set chip address; otherwise repeat data sampling, determination and transmission;

If the data transmitted is determined as a chip initial address setting command data, set the chip initial address at the chip initial address setting by command module 400, and the chip initial address is added by one after receiving a group of display command data; otherwise repeat the data sampling, determination and transmission;

If the data transmitted is determined as a display command data, determine if the E-fuse address stored in module 500 is identical to the chip initial address stored in module 400; if yes, sample and store display data of corresponding address and output display with PWM constant current; if not, then ignore.

After using the present invention, a dual-line cascade application system which simultaneously supplying electrical power and transmitting data can be achieved. It is compatible to the original application system without increase in usage costs; it can increase reliability of LED display cascade application system and the display refresh rate. It is possible to use the cascade LED display application system in a safe, effective and accurate manner.

The present invention provides a dual-line cascade application system and implementation method thereof for simultaneously supplying electrical power and transmitting data. It is compatible to the original application system without increase in usage costs; it can increase reliability of LED display cascade application system and the display refresh rate. It is possible to use the cascade LED display application system in a safe, effective and accurate manner. Certainly, the present invention is not only applicable for LED display dual-line cascade application system, but it is also applicable for other cascade application systems (such as power line and data line separation and so forth).

The above description uses the preferred embodiments to describe the present invention in detail, not to limit the scope of the present invention. Therefore, technical solutions that can be obtained by a person skilled in the art according to the concept of the present invention through logic analysis, reasoning, or limited experimentation, such as application on series application LED display, parallel application LED display, parallel application industrial control, series application industrial control, other cascade application systems and so forth (such as power line and data line separation, etc.) are all within the meaning of the present invention and should all fall within the scope of the present invention.

What is claimed is:

1. A dual-line cascade application system for simultaneously supplying electrical power and transmitting data comprising a controller, cascade chips and LED lights; the controller is connected to the cascade chips; the cascade chips are connected to the LED lights; characterized in that: each of the cascade chips is provided with a voltage clamp module, an electrical power supply module, a data storage module, a PWM constant current output driving circuit, an R end, a G end, a B end, a W end, a VCC/DATA end and a GND/DATA end, as well as a data sampling and calibration module, a power line data sampling and transmission module, a chip initial address setting by command module, a module which determines if E-fuse address is identical to chip initial address, and an E-fuse module which are sequentially connected;
the VCC/DATA end is connected to the voltage clamp module, the data sampling and calibration module and the power line data sampling and transmission module respectively; the voltage clamp module has an output end which is connected to the GND/DATA end and the electrical power supply module respectively; the electrical power supply module has an output end which is connected to the data sampling and calibration module, the power line data sampling and transmission module, the chip initial address setting by command module, the module which determines if E-fuse address is identical to chip initial address, the E-fuse module, the data storage module and the PWM constant current output driving circuit respectively to supply power; the power line data sampling and transmission module has an output end which is connected to the chip initial address setting by command module and the data storage module respectively; the module which determines if E-fuse address is identical to chip initial address is connected to the data storage module; the PWM constant current output driving circuit is connected to the R end, the G end, the B end and the W end;
each of the cascade chips is further provided with an oscillation circuit and a reset circuit; the oscillation circuit and the reset circuit are connected between the electrical power supply module and the power line data sampling and transmission module.

2. The dual-line cascade application system for simultaneously supplying electrical power and transmitting data as in claim 1, characterized in that: the controller is provided with a VDD end and a GND end; the VDD end and the GND end of the controller are connected to the VDD and GND ends of all the cascade chips respectively; each of the LED lights is connected to the R end, the G end, the B end and the W end of each of the cascade chips.

3. An implementation method of the dual-line cascade application system for simultaneously supplying electrical power and transmitting data comprising the following steps:
Step 1: Achieve stable and accurate power and data transmission during cascade application via the voltage clamp module;
Step 2: Data is transmitted to the data sampling and calibration module; data transmission criteria is changed in real time via the data sampling and calibration module for accurate data sampling and transmission; after data sampling and transmission, the power line data sampling and transmission module samples and transmits data;
Step 3: If the data transmitted is determined as an address writing command, write address on the E-fuse module of the chip and set chip address;
otherwise repeat data sampling, determination and transmission;
Step 4: If the data transmitted is determined as a chip initial address setting command data, set chip initial address, and the chip initial address is added by one after receiving a group of display command data; otherwise repeat data sampling, determination and transmission;
Step 5: If the data transmitted is determined as display command data, determine if the E-fuse address is identical to the chip initial address; if yes, sample and store display data of corresponding address and output display with PWM constant current; if not, then ignore.
